(19) United States
(12) Patent Application Publication
(10) Pub. No.: US 2010/0285755 A1
(43) Pub. Date: Nov. 11, 2010

(54) SEQUENCE NUMBER ESTABLISHING METHOD, WIRELESS COMMUNICATION TERMINAL APPARATUS AND WIRELESS COMMUNICATION BASE STATION APPARATUS

(75) Inventors: Takashi Iwai, Ishikawa (JP); Daichi Imamura, Kanagawa (JP); Yoshihiko Ogawa, Kanagawa (JP); Sadaki Futagi, Ishikawa (JP); Atsushi Matsumoto, Ishikawa (JP); Tomofumi Takata, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/810,291

(22) PCT Filed: Dec. 26, 2008
(86) PCT No.: PCT/JP2008/004003

§ 371 Date: Jun. 23, 2010

(30) Foreign Application Priority Data
Dec. 27, 2007 (JP) 2007-337240

(51) Int. Cl. H04B 1/00

(52) U.S. Cl. 455/68

(57) ABSTRACT

A wireless communication terminal apparatus wherein the occurrences of inter-sequence interferences between cells can be reduced. In this apparatus, a sequence number deciding part (105) has a table in which the sequence numbers of a plurality of Zadoff-Chu sequences having different sequence lengths are associated with the sequence group numbers of a plurality of sequence groups into which the Zadoff-Chu sequences are grouped and with the transmission bandwidths of reference signals. In accordance with a sequence group number and a transmission bandwidth both received from a decoding part (104), the sequence number deciding part (105) refers to the table to decide the sequence number of a Zadoff-Chu sequence. In the table of the sequence number deciding part (105), the intervals of the sequence numbers of the Zadoff-Chu sequences used for the reference signals are established in accordance with the sequence lengths.

### TECHNICAL FIELD

The present invention relates to a sequence index setting method, a radio communication terminal apparatus and a radio communication base station apparatus.

### BACKGROUND ART

In a mobile communication system, a reference signal (RS) is used for uplink or downlink channel estimation. In a radio communication system represented by a 3GPP LIE system (3rd Generation Partnership Project Long Term Evolution), a Zadoff-Chu sequence (hereinafter “ZC sequence”) is adopted as a reference signal that is used in uplink. Reasons that a ZC sequence is adopted as a reference signal include a uniform frequency characteristic, and good auto-correlation and cross-correlation characteristics. A ZC sequence is a kind of CAZAC (Constant Amplitude and Zero Auto-correlation Code) sequence and represented in the time domain by following equation 1,

$$\begin{matrix}( Equation 1 ) & \\ {f}_{r} ( k ) = \{ \begin{matrix}exp \{ \frac{- j2π r}{N} ( \frac{k ( k + 1 )}{2} + p k ) \} , when N is odd , k = 0 , 1 , … , N - 1 \\ exp \{ \frac{- j2π r}{N} ( \frac{{k}^{2}}{2} + p k ) \} , when N is even , k = 0 , 1 , … , N - 1\end{matrix} & [ 1 ]\end{matrix}$$

Here, “N” is the sequence length, “r” is the ZC sequence index in the time domain, and “N” and “r” are coprime. Also, “p” represents an arbitrary integer (generally p=0). Although cases will be explained with the following explanation using ZC sequences where sequence length N is an odd number, ZC sequences where sequence length N is an even number will be equally applicable.

A cyclic shift ZC sequence obtained by cyclic-shifting the ZC sequence of equation 1 in the time domain, or a ZC-ZCZ (Zadoff-Chu Zero Correlation Zone) sequence, is represented by following equation 2,

$$\begin{matrix}( Equation 2 ) & \\ {f}_{r , m} ( k ) = exp \{ \frac{- j2π r}{N} ( \frac{( k \pm m Δ ) ( k \pm m Δ + 1 )}{2} ) + p k \} , when N is odd , k = 0 , 1 , … , N - 1 & [ 2 ]\end{matrix}$$

where “m” represents the cyclic shift index, “Δ” represents the cyclic shift interval, and the sign “±” is either positive or negative. Further, N−1 quasi-orthogonal sequences with good cross-correlation characteristics can be generated from a ZC sequence of sequence length. N of a prime number. In this case, the cross-correlation between generated N−1 quasi-orthogonal sequences is constant at vN. Furthermore, the sequence obtained by Fourier-transforming the time-domain ZC sequence of equation 1 to a frequency-domain sequence is also a ZC sequence, and therefore a frequency-domain ZC sequence is represented by following equation 3,

$$\begin{matrix}( Equation 3 ) & \\ {F}_{u} ( k ) = exp \{ \frac{- j2π u}{N} ( \frac{k ( k + 1 )}{2} + qk ) \} , when N is odd , k = 0 , 1 , … , N - 1 & [ 3 ]\end{matrix}$$

where “N” is the sequence length, “u” is the ZC sequence index in the frequency domain, and “N” and “u” are coprime. Also, “q” represents an arbitrary integer (generally q=0). Likewise, in the frequency-domain representation of the time-domain ZC-ZCZ sequence of equation 2, cyclic shift and phase rotation form a Fourier transform pair, and therefore a frequency-domain ZC-ZCZ sequence is represented by following equation 4,

$$\begin{matrix}( Equation 4 ) & \\ {F}_{u , m} ( k ) = exp \{ \frac{- j2π u}{N} ( \frac{k ( k + 1 )}{2} + qk ) \pm \frac{j2πΔ m}{N} k \} , when N is odd , k = 0 , 1 , … , N - 1 & [ 4 ]\end{matrix}$$

where “N” is the sequence length, “u” is the ZC sequence index in the frequency domain, and “N” and “u” are coprime, and where “m” represents the cyclic shift index, “Δ” represents the cyclic shift interval and “q” represents an arbitrary integer (generally q=0).

Further, a reference signal used in an uplink in 3GPP LIE includes a reference signal for channel estimation used to demodulate data (hereinafter “DM-RS,” which stands for demodulation reference signal). This DM-RS is transmitted in the same bandwidth as the data transmission bandwidth. That is, when the data transmission bandwidth is narrow, a DM-RS is transmitted in a narrow band. For example, if the data transmission bandwidth is one RB (resource block), the DM-RS transmission bandwidth is also one RB, and, if the data transmission bandwidth is two RBs, the DM-RS transmission bandwidth is also two RBs. In 3GPP LTE, one RB is formed with twelve subcarriers, so that a DM-RS is transmitted in a transmission bandwidth of an integral multiple of twelve subcarriers. Further, sequence length N of a ZC sequence is the maximum prime number among the prime numbers less than the number of subcarriers equivalent to the transmission bandwidth. For example, if a DM-RS is transmitted in 3 RBs (36 subcarriers), a ZC sequence of sequence length N=31 is generated, and, if a DM-RS is transmitted in 4 RBs (48 subcarriers), a ZC sequence of sequence length N=47 is generated.

A ZC sequence having sequence length N of a prime number, does not match the number of subcarriers equivalent to the DM-RS transmission bandwidth (integral multiple of 12). Then, to match a ZC sequence having sequence length N of a prime number with the number of subcarriers equivalent to the DM-RS transmission bandwidth, a ZC sequence of a prime number is subject to cyclic extension, to match the number of subcarriers in the transmission band. For example, by duplicating the first half of a ZC sequence and attaching the duplicated part to the second half, the number of subcarriers equivalent to the transmission bandwidth is matched with the sequence length of the ZC sequence. To be more specific, in cases where there is a 3-RB (36-subcarrier) DM-RS, a ZC sequence of sequence length N=36 is generated by giving a cyclic extension of 5 subcarriers to the ZC sequence of sequence length N=31, and, when a DM-RS is transmitted in 4 RBs (48 subcarriers), a ZC sequence of sequence length N=48 is generated by giving a cyclic extension of 1 subcarrier to the ZC sequence of sequence length N=47.

As described above, in 3GPP LTE, sequence length N varies depending on the reference signal transmission bandwidth (i.e. the numbers of RBs of reference signals). Accompanying this, when the transmission bandwidth varies, the sequence index of the ZC sequence to use for a reference signal also varies. Then, in 3GPP LTE, studies are underway to group a plurality of ZC sequences of different sequence lengths N into a plurality of sequence groups. A plurality of sequence groups generated by this grouping method are allocated to cells on a one-by-one basis. In 3GPP LIE, the number of sequence groups is 30 (=N−1) equaling to the number of ZC sequences of sequence length N−31 that can be generated from 3 RBs, the minimum transmission bandwidth (i.e. the minimum number of RBs) using a ZC sequence. Further, in the transmission bandwidths, one sequence is assigned to RBs per one sequence group from 3 RBs to 5 RBs, and two sequences are assigned to RBs of 6 RBs or more per one sequence group.

As a method of grouping ZC sequences, a method of assigning ZC sequences to sequence groups in each transmission bandwidth (i.e. each number of RBs) in order from a smaller sequence index, is proposed (e.g. see Non-Patent Document 1). To be more specific, as shown in FIG. 1, in transmission bandwidths of 3 RBs to 5 RBs to which one sequence is assigned per one sequence group, one of ZC sequences of sequence indexes u=1, 2 and 3 . . . is assigned to sequence groups 1, 2 and 3 . . . . Further, as shown in FIG. 1, transmission bandwidths of 6-RBs or more to which two sequences are assigned per sequence group, the two ZC sequences having sequence indexes u=(1,2), (3,4) and (5,6) . . . are assigned to sequence groups 1, 2 and 3 . . . . In this way, sequence indexes of ZC sequences to use for reference signals of transmission bandwidths (i.e. the numbers of RBs) are assigned in order from a smaller sequence index, so that, sequence groups can be determined using a small amount of calculation.

### Non-Patent Document 1: Huawei, R1-073518, “Sequence Grouping Rule for UL DM-RS,” 3GPP TSG RAN WG1 Meeting #50, Athens, Greece, Aug. 20-24, 2007

### DISCLOSURE OF INVENTION

### Problems to be Solved by the Invention

FIG. 2 shows the distribution of u/Ns of ZC sequences (ZC sequences of sequence indexes u shown in FIG. 1) grouped into a plurality of sequence groups by the above-described conventional technique. The horizontal axis shows u/Ns and the longitudinal axis shows transmission bandwidths (i.e. the numbers of RBs). As shown in FIG. 2, when the ZC sequences have a wider transmission bandwidth (i.e. the number of wider RBs), u/Ns of ZC sequences used for reference signals are concentrated to be zero. That is, between cells to which different sequence groups are assigned, with the above-described conventional technique, it is likely to use ZC sequences showing nearly zero difference in u/N, between ZC sequences of varying sequence lengths.

Here, it is known that combinations of sequence indexes of high cross-correlation are present among ZC sequences of varying sequence lengths. According to computer simulations conducted by the present inventors, the relationships between u/Ns and maximum cross-correlation values are as shown in FIG. 3. FIG. 3 shows cross-correlation between a desired wave having a 1-RB transmission bandwidth and interference waves having transmission bandwidths of 1 RB to 25 RBs. The horizontal axis shows the difference in u/N between the desired wave and interference waves, and the longitudinal axis shows the maximum cross-correlation values between the desired wave and interference waves. From FIG. 3, when the difference in u/N between ZC sequences becomes close to zero (e.g. the difference in u/N is within 0.02), it is known that the maximum cross-correlation value between those ZC sequences increases (e.g. the maximum cross-correlation value is equal to or more than 0.7). That is, when ZC sequences showing a difference in u/N close to zero are used at the same time between different cells, the ZC sequence to use for the reference signal for one cell is significantly interfered from ZC sequences to use for a reference signal for the other cell, and therefore, an error occurs in a channel estimation result.

For example, it is known that many ZC sequences in sequence groups other than sequence group 2 are included in the range where the difference in u/N from the ZC sequence of sequence group 2 in a 3-RB transmission bandwidth is within 0.02 (the dotted frame shown in FIG. 2). Interference is likely to occur between these ZC sequences of varying sequence lengths. That is, ZC sequences are grouped simply in order from the smallest number of sequence index as the above-described conventional technique, interference between sequences are likely to occur between cells to which different sequence groups are assigned.

It is therefore an object of the present invention to provide a sequence index setting method, a radio communication terminal apparatus and a radio communication base station apparatus that can reduce the interference of sequences between cells.

### Means for Solving the Problem

The sequence index setting method of the present invention that uses as a reference signal a Zadoff-Chu sequence having a sequence length in accordance with a transmission bandwidth of the reference signal, includes determining an interval between sequence indexes of the Zadoff-Chu sequences in accordance with the sequence length.

### ADVANTAGEOUS EFFECTS OF INVENTION

According to the present invention, it is possible to reduce the interference of sequences between cells.

### BRIEF DESCRIPTION OF DRAWINGS

FIG. 1 shows a conventional table for determining sequence indexes;

FIG. 2 shows conventional distribution of u/Ns of ZC sequences to use for reference signals;

FIG. 3 shows cross-correlation about the difference in u/N between ZC sequences of varying sequence lengths;

FIG. 4 is a block diagram showing a configuration of a terminal according to Embodiment 1 of the present invention;

FIG. 5 is a block diagram showing a configuration of a base station according to Embodiment 1 of the present invention;

FIG. 6 shows a table for determining sequence indexes according to Embodiment 1 of the present invention;

FIG. 7 shows the distribution of u/Ns of ZC sequences to use for reference signals according to Embodiment 1 of the present invention;

FIG. 8A is a block diagram showing another internal configuration of the reference signal generation section according to Embodiment 1 of the present invention;

FIG. 8B is a block diagram showing another internal configuration of the reference signal generation section according to Embodiment 1 of the present invention;

FIG. 9 shows a table for determining sequence indexes according to Embodiment 2 of the present invention;

FIG. 10 shows the distribution of u/Ns of ZC sequences to use for reference signals according to Embodiment 2 of the present invention;

FIG. 11 shows a table for determining sequence indexes (setting example 1) according to Embodiment 3 of the present invention;

FIG. 12 shows the distribution of u/Ns of ZC sequences to use for reference signals (setting example 1) according to Embodiment 3 of the present invention;

FIG. 13 shows a table for determining sequence groups (setting example 2) according to Embodiment 3 of the present invention; and

FIG. 14 shows the distribution of u/Ns of ZC sequences to use for reference signals (setting example 2) according to Embodiment 3 of the present invention.

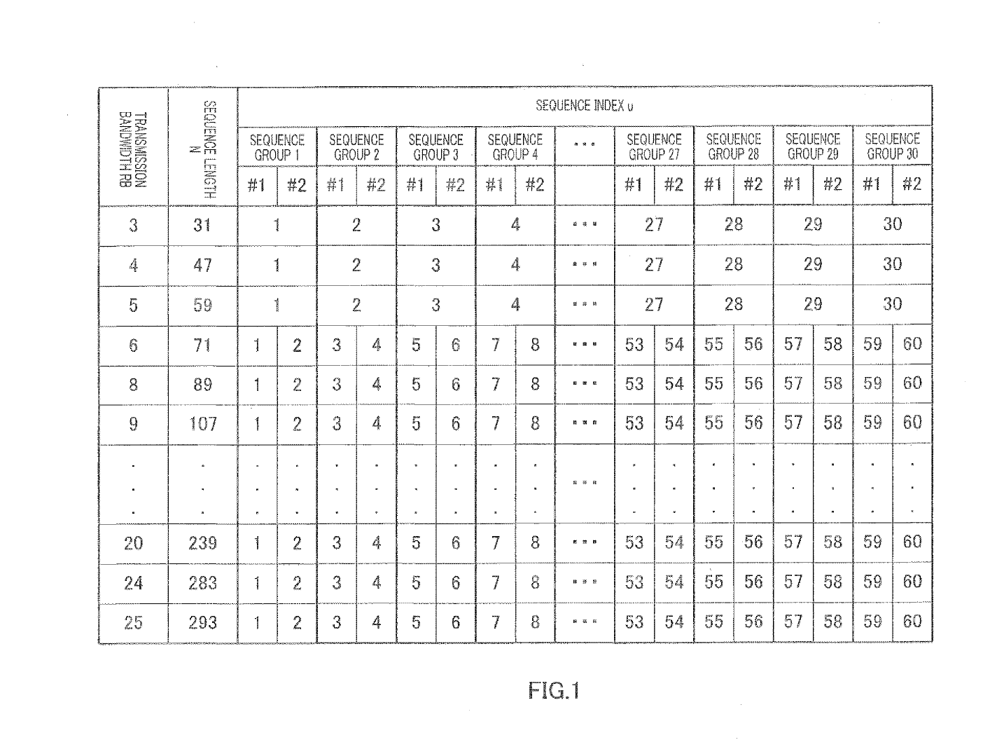

### BEST MODE FOR CARRYING OUT THE INVENTION

Now, embodiments of the present invention will be described in detail with reference to the accompanying drawings.

### Embodiment 1

With the present embodiment, intervals between sequence indexes of ZC sequences are determined in accordance with sequence lengths.

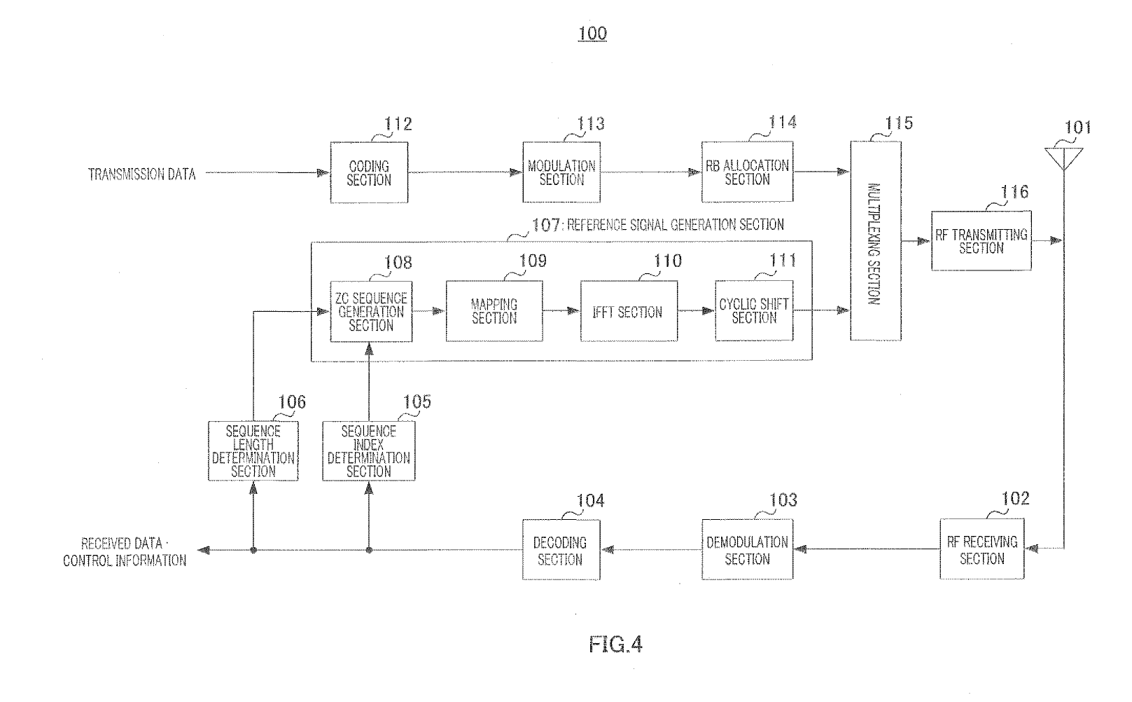

The configuration of terminal 100 according to the present embodiment will be described using FIG. 4.

RF receiving section 102 of terminal 100 shown in FIG. 4 performs receiving processing including down-conversion and A/D conversion on a signal received via antenna 101, and outputs the signal subjected to receiving processing to demodulation section 103.

Demodulation section 103 performs equalization processing and demodulation processing on the signal received as input from RF receiving section 102, and outputs the signal after these processing to decoding section 104.

Decoding section 104 decodes the signal received as input from demodulation section 103, and extracts received data and control information. Then, decoding section 104 outputs the sequence group index among the extracted control information to sequence index determination section 105, and outputs the reference signal transmission bandwidth (i.e. the number of RBs) to sequence index determination section 105 and sequence length determination section 106.

Sequence index determination section 105 has a table in which sequence group indexes of a plurality of sequence groups grouping a plurality of different ZC sequences of varying sequence lengths and the reference signal transmission bandwidths (the numbers of RBs), and the sequence indexes of ZC sequences are associated, and determines a sequence index of a ZC sequence according to the sequence group indexes and the transmission bandwidth (i.e. the number of RBs) received as input from decoding section 104, with reference to the table. Further, in the table in sequence index determination section 105, intervals between sequence indexes of ZC sequences to use for reference signals are determined in accordance with sequence lengths. Then, sequence index determination section 105 outputs the determined sequence index to ZC sequence generation section 108 in reference signal generation section 107.

Based on the transmission bandwidth (i.e. the number of RBs) received as input from decoding section 104, sequence length determination section 106 determines the sequence length of a ZC sequence. To be more specific, sequence length determination section 106 determines the maximum prime number among the prime numbers smaller than the number of subcarriers equivalent to the transmission bandwidth (i.e. to the number of RBs), to be the sequence length of a ZC sequence. Then, sequence length determination section 106 outputs the determined sequence length to ZC sequence generation section 108 in reference signal generation section 107.

Reference signal generation section 107 has ZC sequence generation section 108, mapping section 109, IFFT (Inverse Fast Fourier Transform) section 110 and cyclic shift section 111. Then, reference signal generation section 107 generates as a reference signal a ZC sequence obtained by adding a cyclic shift to the ZC sequence generated in ZC sequence generation section 108. Then, reference signal generation section 107 outputs the generated reference signal to multiplexing section 115. Now, the internal configuration of reference signal generation section 107 will be described.

ZC sequence generation section 108 generates a ZC sequence based on the sequence index received as input from sequence index determination section 105 and the sequence length received as input from sequence length determination section 106. Then, ZC sequence generation section 108 outputs the generated ZC sequence to mapping section 109.

Mapping section 109 maps the ZC sequence received as input from ZC sequence generation section 108 to the band corresponding to the transmission bandwidth of terminal 100. Then, mapping section 109 outputs the mapped ZC sequence to IFFT section 110.

IFFT section 110 performs IFFT processing for the ZC sequence received as input from mapping section 109. Then, IFFT section 110 outputs the ZC sequence after IFFT processing to cyclic shift section 111.

Based on the predetermined amount of cyclic shift, cyclic shift section 111 cyclic-shifts for the ZC sequence received as input from IFFT section 110. Then, cyclic shift section 111 outputs the cyclic-shifted ZC sequence to multiplexing section 115.

Coding section 112 encodes transmission data, and outputs the encoded data to modulation section 113.

Modulation section 113 modulates the encoded data received as input from coding section 112, and outputs the modulated signal to RB allocation section 114.

RB allocation section 114 allocates the modulated signal received as input from modulation section 113 to the band (RB) corresponding to the transmission bandwidth of terminal 100, and outputs the modulated signal allocated to the band (RB) corresponding to the transmission bandwidth of terminal 100 to multiplexing section 115.

Multiplexing section 115 time-multiplexes the transmission data (modulated signal) received as input from RB allocation section 114 and the ZC sequence (reference signal) received as input from cyclic shift section 111 of reference signal generation section 107, and outputs the multiplexed signal to RF transmitting section 116. The multiplexing method in multiplexing section 115 is not limited to time multiplexing, and may be frequency multiplexing, code multiplexing and IQ multiplexing on a complex space.

RE transmitting section 116 performs transmission processing, including D/A conversion, up-conversion and amplification, on the multiplexed signal received as input from multiplexing section 115, and transmits via radio the signal after the transmission processing from antenna 101 to the base station.

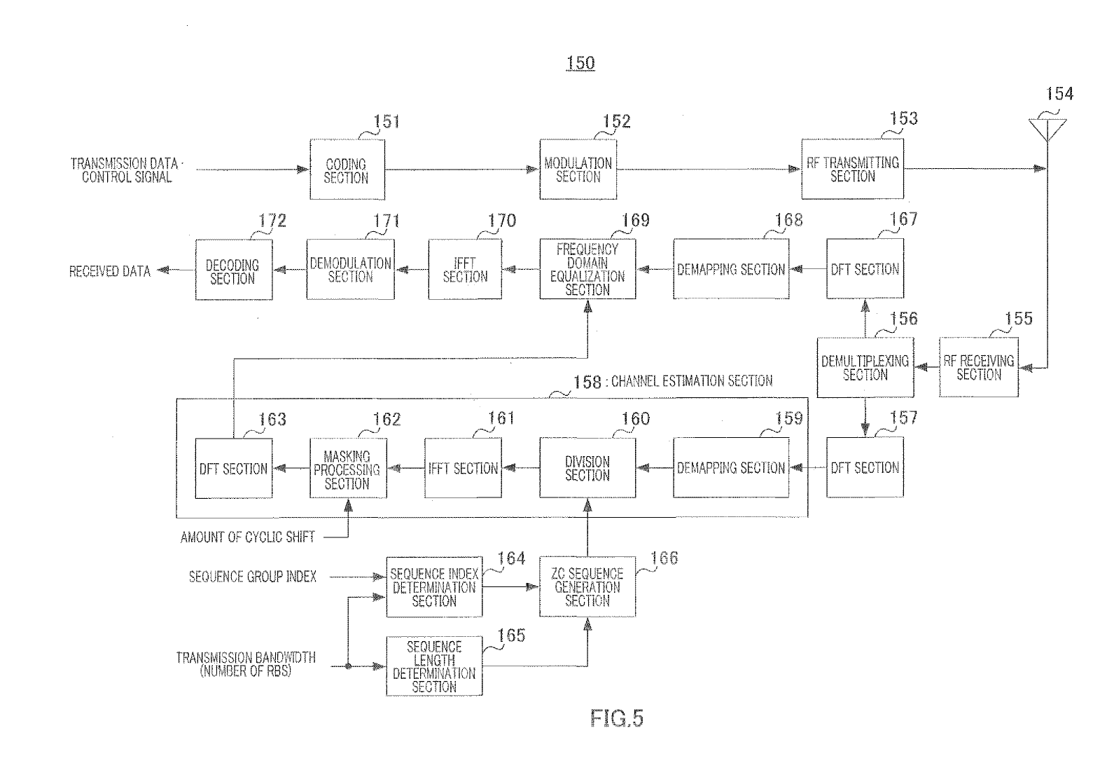

Next, the configuration of base station 150 according to the present embodiment will be explained using FIG. 5.

Coding section 151 in base station 150 shown in FIG. 5 encodes transmission data and a control signal, and outputs the encoded data to modulation section 152. The control signal includes a sequence group index showing the sequence group allocated to base station 150 and the transmission bandwidth (i.e. the number of RBs) of the reference signal transmitted by terminal 100.

Modulation section 152 modulates the coded data received as input from coding section 151, and outputs the modulated signal to RF transmitting section 153.

RF transmitting section 153 performs transmission processing, including D/A conversion, up-conversion and amplification, on the modulated signal, and transmits the signal after the transmission processing via radio from antenna 154.

RF receiving section 155 performs receiving processing, including down-conversion and A/D conversion, on a signal received via antenna 154, and outputs the signal after the receiving processing to demultiplexing section 156.

Demultiplexing section 156 demultiplexes the signal outputted from RF receiving section 155 into the reference signal, data signal and control signal. Demultiplexing section 156 outputs the demultiplexed reference signal to DFT (Discrete Fourier transform) section 157 and outputs the data signal and control signal to DFT section 167.

DFT section 157 performs DFT processing on the reference signal received as input from demultiplexing section 156, to transform the time-domain signal to a frequency-domain signal. DFT section 157 outputs the reference signal transformed into the frequency domain, to demapping section 159 of channel estimation section 158.

Channel estimation section 158, which has demapping section 159, division section 160, IFFT section 161, masking processing section 162 and DFT section 163, estimates channels based on the reference signal outputted from DFT section 157. Now, the internal configuration of channel estimation section 158 will be described specifically.

Demapping section 159 extracts the parts corresponding to the transmission band of each terminal from the signal received as input from DFT section 157. Demapping section 159 outputs the extracted signals to division section 160.

Division section 160 divides the signals received as input from demapping section 159 by ZC sequences received as input from ZC sequence generation section 166 (described later). Then, division section 160 outputs the division results (correlation values) to IFFT section 161.

IFFT section 161 performs IFFT processing on the signals outputted from division section 160. Then, IFFT section 161 outputs the signals after the IFFT processing to masking processing section 162.

Based on the amount of cyclic shift received as input, by masking the signals received as input from IFFT section 161, masking processing section 162 as an extraction means extracts the correlation value in the period (the detection window) where the correlation value of the desired cyclic shift sequence is present. Then, masking processing section 162 outputs the extracted correlation value to DFT section 163.

DFT section 163 performs DFT processing on the correlation value received as input from masking processing section 162. Then, DFT section 163 transforms the correlation value after DFT processing to frequency domain equalization section 169. The signal outputted from DFT section 163 shows frequency fluctuation of the channel (the frequency response of the channel).

Sequence index determination section 164 having the same table as in sequence index determination section 105 (FIG. 4) of terminal 100, that is, a table in which sequence group indexes and transmission bandwidths (i.e. the numbers of RBs), and the sequence indexes are associated, determines the sequence index according to the sequence group index and the transmission bandwidth (i.e. the number of RBs) received as input, with reference to the table. That is, in the table in sequence index determination section 164, intervals between sequence indexes of ZC sequences to use for reference signals are determined in accordance with sequence lengths. Then, sequence index determination section 164 outputs the determined sequence index to ZC sequence generation section 166.

Based on the transmission bandwidth (i.e. based on the number of RBs) received as input, sequence length determination section 165 determines the sequence length of a ZC sequence similar to sequence length determination section 106 of terminal 100 (FIG. 4). Then, sequence length determination section 165 outputs the determined sequence length to ZC sequence generation section 166.

Similar to ZC sequence generation section 108 of terminal 100 (FIG. 4), ZC sequence generation section 166 generates a ZC sequence based on the sequence index received as input from sequence index determination section 164 and the sequence length received as input from sequence length determination section 165. Then, ZC sequence generation section 166 outputs the generated ZC sequence to division section 160 in channel estimation section 158.

Meanwhile, DFT section 167 performs DFT processing on the data signal and the control signal received as input from demultiplexing section 156, to transform the time-domain signal to a frequency-domain signal. DFT section 167 outputs the data signal and control signal transformed into the frequency domain, to demapping section 168.

Demapping section 168 extracts the parts of the data signal and control signal corresponding to the transmission band of each terminal from the signal received as input from DFT section 167, and outputs the extracted signals to frequency domain equalization section 169.

Frequency domain equalization section 169 performs equalization processing on the data signal and control signal received as input from demapping section 168, using the signal which is received as input from DFT section 163 in channel estimating section 158 (the frequency response of the channel). Frequency domain equalization section 169 outputs the signals subjected to equalization processing to IFFT section 170.

IFFT section 170 performs IFFT processing on the data signal and control signal received as input from frequency domain equalization section 169. IFFT section 170 outputs the signals subjected to IFFT processing to demodulation section 171.

Demodulation section 171 demodulates the signals received as input from IFFT section 170, and outputs the signals subjected to demodulation processing to decoding section 172.

Decoding section 172 decodes the signals received as input from demodulation section 171, and extracts received data.

Next, an example of determining sequence indexes in sequence index determination section 105 of terminal 100 (FIG. 4) and sequence index determination section 164 of base station 150 (FIG. 5) will be explained.

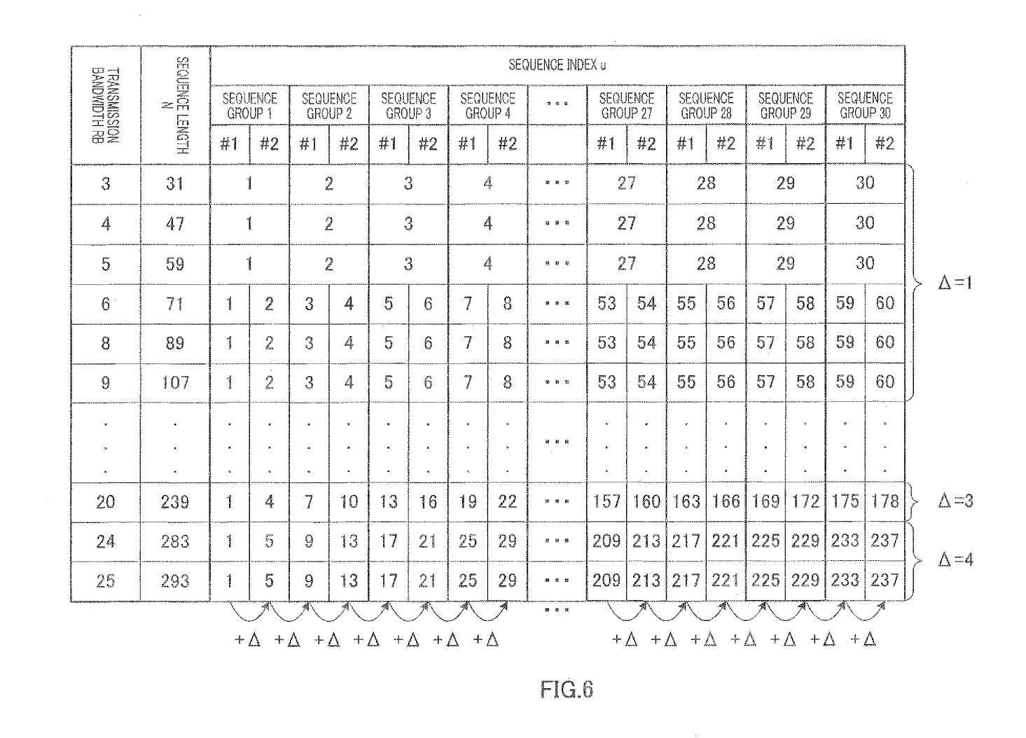

In the following explanation, the number of sequence groups is thirty (sequence groups 1 to 30). Further, as the reference signal transmission bandwidth (i.e. the number of RBs), the number of RBs is equal to or more than three and is a multiple of two, three or five. Specifically, as the reference signal transmission bandwidth (i.e. the number of RBs), 3 RBs, 4 RBs, 5 RBs, 6 RBs, 8 RBs, 9 RBs, 10 RBs, 12 RBs, 15 RBs, 16 RBs, 18 RBs, 20 RBs, 24 RBs and 25 RBs are used. Further, 1 RB is formed with 12 subcarriers. Further, sequence length N of a ZC sequence is the maximum prime number equal to or less than the number of subcarriers equivalent to each transmission bandwidth (i.e. to each number of RBs). To be more specific, as shown in FIG. 6, assuming that the sequence length N is 31 in 3 RBs (36 subcarriers), the sequence length N is 47 in 4 RBs (48 subcarriers), and the sequence length N is 59 in 5 RBs (60 subcarriers). The same will apply to a case where the transmission bandwidth (i.e. the number of RBs) is 6 RBs to 25 RBs. Further, the sequence indexes of ZC sequences of each sequence length are assigned in ascending order to sequence groups 1 to 30. Here, one ZC sequence is assigned per one sequence group in transmission bandwidths of 3 RBs to 5 RBs and two ZC sequences are assigned per one sequence group in transmission bandwidths of 6 RBs or more. That is, with transmission bandwidths (i.e. the numbers of RBs) of 3 RBs to 5 RBs, 30 ZC sequences (=1×30 groups) are used as reference signals in each transmission bandwidth (i.e. in each number of RBs), and with transmission bandwidth of 6 RBs or more, 60 ZC sequences (=2×30 groups) are used as reference signals in each transmission bandwidth (i.e. in each number of RBs). Further, the table shown in FIG. 6 is held in sequence index determination section 105 and sequence index determination section 164.

With the present embodiment, intervals of sequence indexes of ZC sequences to use for reference signals are determined in accordance with sequence lengths. Specifically, an interval between sequence indexes of ZC sequences to use for reference signals is determined to be a value obtained by dividing the number of ZC sequences that can be generated in that sequence length by the number of ZC sequences to use for reference signals. That is, interval Δ of sequence indexes of ZC sequences to use for reference signals is calculated by the following equation,

Δ=floor((number of ZC sequences that can be generated in transmission bandwidth(sequence length N): N−1)/(number of ZC sequences to use for reference signals)) (Equation 5)

where floor(x) means to truncate after the decimal point of x.

Accordingly, as shown in FIG. 6, in the 3-RB transmission bandwidth, the number of ZC sequences that can be generated is 30 (=31−1) and the number of ZC sequences to use for reference signals is 30, and therefore Δ=floor(30/30)=1. Further, in the 4-RB transmission bandwidth, the number of ZC sequences that can be generated is 46 (−47−1) and the number of ZC sequences to use for reference signals is 30, and therefore Δ=floor(46/30)=1. Likewise, as shown in FIG. 6, in the 24-RB transmission bandwidth, the number of ZC sequences that can be generated is 282 (=283−1) and the number of ZC sequences to use for reference signals is 60, and therefore Δ=floor(282/60)=4. Further, in the 25-RB transmission bandwidth, the number of ZC sequences that can be generated is 292 (=293−1) and the number of ZC sequences to use for reference signals is 60, and therefore Δ=floor(292/60)=4. The same will apply to transmission bandwidths of 5 RBs to 20 RBs.

Then, sequence indexes spaced Δ intervals apart are assigned to sequence groups in ascending order from sequence index u=1 in each transmission bandwidth. To be more specific, in transmission bandwidths of 3 RBs to 5 RBs to which one sequence is assigned per one sequence group, sequence indexes are assigned according to equation 6, and, in transmission bandwidths of 6-RBs or more to which two sequences are assigned per sequence group, sequence indexes #1 and #2 are assigned according to equations 7 and 8.

Sequence index=(G−1)×Δ+1 (Equation 6)

Sequence index #1=(G−1)×2×Δ+1 (Equation 7)

Sequence index #2=sequence index #1+Δ (Equation 8)

Here, G represents the sequence group index (here, G=1 to 30).

Accordingly, as shown in FIG. 6, in the 3-RB transmission bandwidth (interval Δ=1), sequence index u=1 (=(1−1)×1+1) is assigned to sequence group 1, sequence index u=2 (=(2−1)×1+1) is assigned to sequence group 2, and sequence index u=3 (=(3−1)×1+1) is assigned to sequence group 3 by equation 6. The same will apply to sequence groups 4 to 30 in the 3-RB transmission bandwidth.

Accordingly, as shown in FIG. 6, in the 25-RB transmission bandwidth (interval Δ=4), sequence index u=1 (=(1−1)×2×4+1) is assigned as sequence index #1 to sequence group 1, and sequence index u=5 (=1+4) is assigned as sequence index #2 to sequence group 1 by equations 7 and 8. Likewise, sequence index u=9 (=(2−1)×2×4+1) is assigned as sequence index #1 to sequence group 2, and sequence index u=13 (=9+4) is assigned as sequence index #2 to sequence group 2. Further, sequence index u=17 (=(3−1)×2×4+1) is assigned as sequence index #1 to sequence group 3, and sequence index u=21 (=17+4) is assigned as sequence index #2 to sequence group 3. The same will apply to sequence groups 4 to 30 in the 25-RB transmission bandwidth.

Regarding transmission bandwidths of 4 RBs to 24 RBs, sequence indexes are assigned in the same way.

Sequence index determination section 105 of terminal 100 (FIG. 4) and sequence index determination section 164 of base station 150 (FIG. 5) have a table in which sequence indexes of ZC sequences to use for reference signals as described above and which is shown in FIG. 6, determines sequence indexes based on sequence group indexes and transmission bandwidths (i.e. the numbers of RBs). Assuming that sequence group 2 is assigned to base station 150 and the reference signal transmission bandwidth transmitted by terminal 100 belonging to base station 150 is 20 RBs, sequence index determination section 105 of terminal 100 (FIG. 4) and sequence index determination section 164 of base station 150 (FIG. 5) output sequence index #1=7 and sequence index #2=10 associated with a 20-RB transmission bandwidth and sequence group 2, with reference to the table shown in FIG. 6. Further, in transmission bandwidths to which two sequences are assigned per sequence group, it is determined to use either sequence index #1 or sequence index #2 as a reference signal based on predetermined rules. The predetermined rules include that sequence index #1 is used when a slot number is an odd number, and sequence index #2 is used when a slot number is an even number.

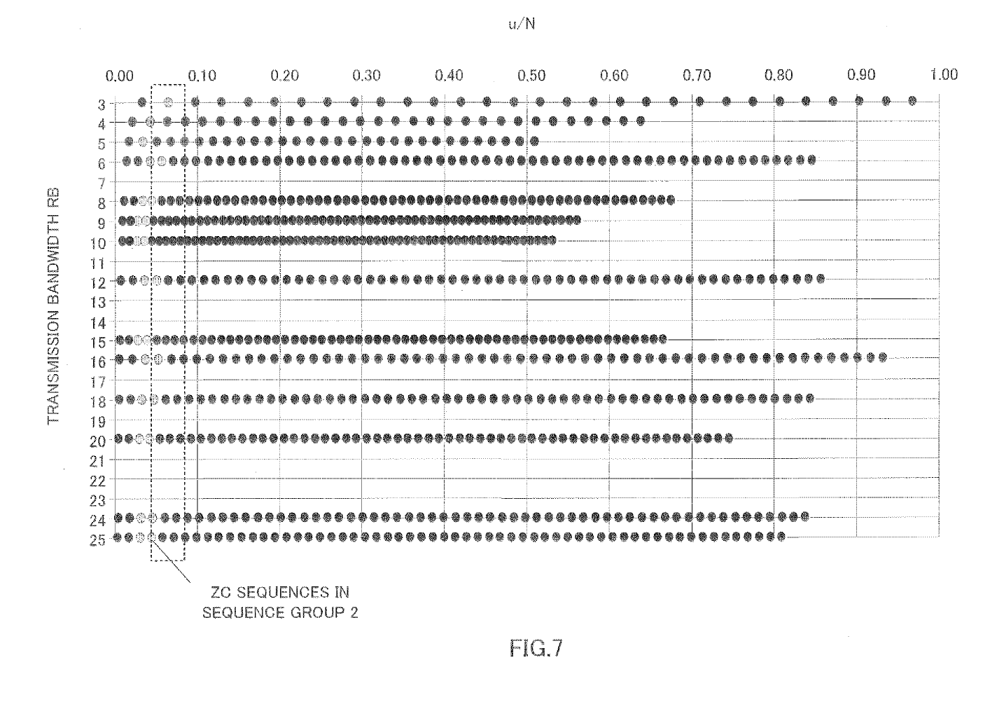

Next, FIG. 7 shows the distribution of u/Ns of the ZC sequences to use for reference signals (i.e. ZC sequences assigned in the table shown in FIG. 6). For example, in the 4-RB transmission bandwidth (sequence length N=47), sequence index interval Δ=1, so that u/Ns of ZC sequences in the 4-RB transmission bandwidth shown in FIG. 7 are distributed at 1/47 intervals. Further, in the 5-RB transmission bandwidth (sequence length N=59), sequence index interval Δ=1, so that u/Ns of ZC sequences in the 5-RB transmission bandwidth shown in FIG. 7 are distributed at 1/59 intervals. Likewise, in the 25-RB transmission bandwidth (sequence length N=293), sequence index interval Δ=4, so that u/Ns of ZC sequences in the 25-RB transmission bandwidth shown in FIG. 7 are distributed at 4/293 intervals. The same will apply to transmission bandwidths of 6 RBs to 24 RBs. That is, as shown in FIG. 7, in each transmission bandwidth (i.e. in each number of RBs), u/Ns of ZC sequences to use for reference signals are distributed evenly in a range from 0 to 1. Further, in each transmission bandwidth (i.e. in each number of RBs), interval Δ between ZC sequences is determined to be the greatest interval among the intervals such that u/Ns of ZC sequences to use for reference signals are distributed evenly in a range from 0 to 1. Accordingly, in each transmission bandwidth (in each number of RBs), u/Ns of ZC sequences to use for reference signals are distributed over the entirety from 0 to 1 in a dispersed manner.

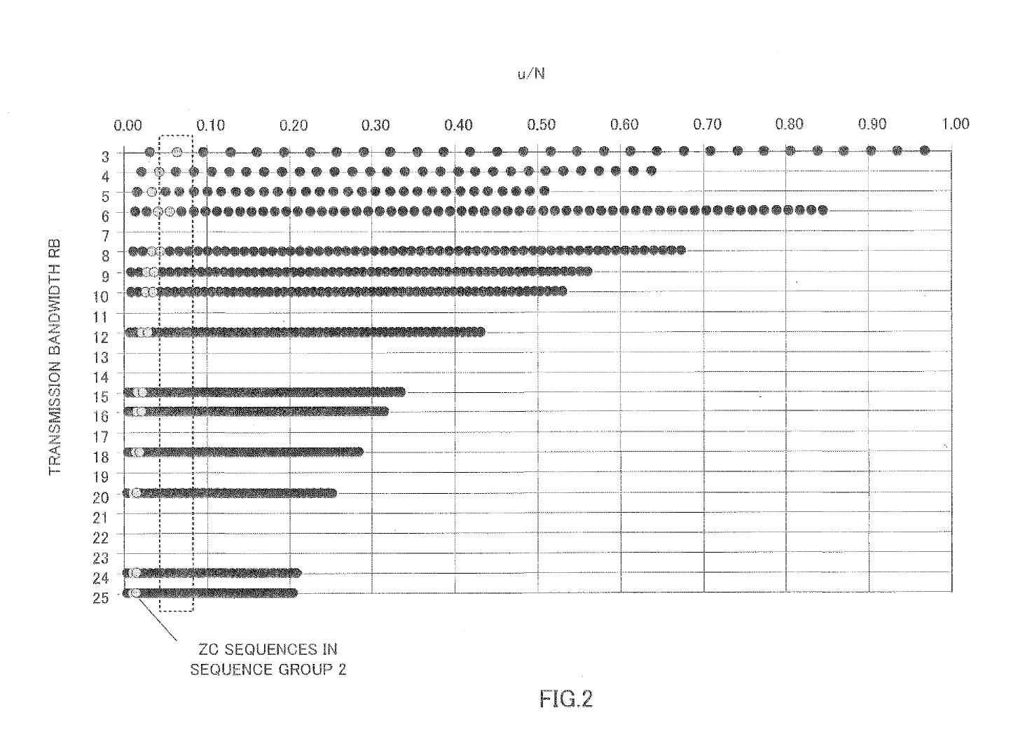

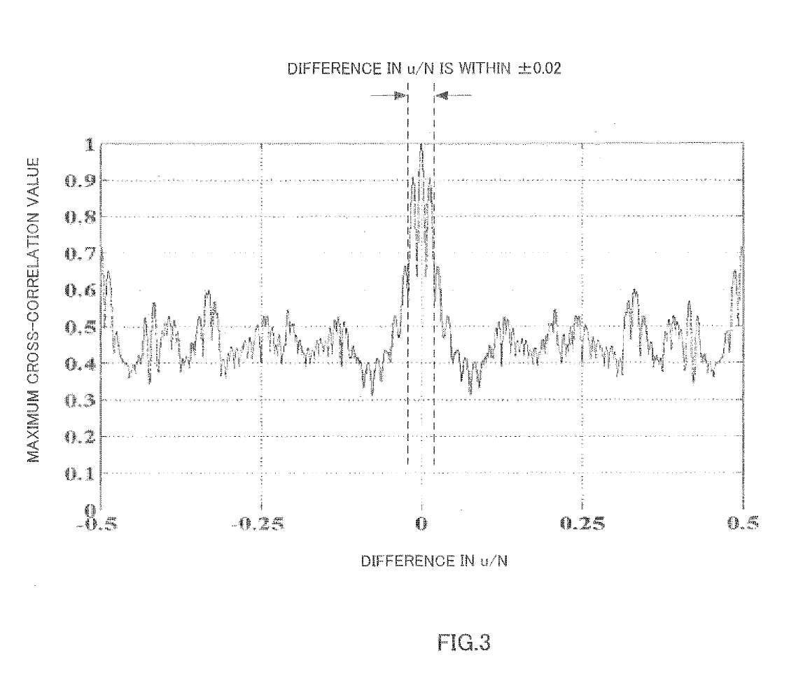

Here, the distribution of u/Ns in FIG. 7 and the distribution of u/Ns in FIG. 2 are compared. In the distribution of u/Ns shown in FIG. 2, u/Ns are concentrated to be zero when a transmission bandwidth (i.e. the number of RBs) is greater as described above. By contrast with this, in the distribution of u/Ns shown in FIG. 7, u/Ns are dispersed evenly at Δ/N intervals even when the transmission bandwidth (i.e. the number of RBs) is greater. That is, u/Ns of ZC sequences to use for reference signals are dispersed over the entirety from 0 to 1 over transmission bandwidths of 3 RBs to 25 RBs. For this reason, u/Ns between ZC sequences of different transmission bandwidths (varying sequence lengths) are little likely to be the same, that is, the difference in u/N between ZC sequences is little likely to be close to zero. For example, the number of ZC sequences in sequence groups other than sequence group 2 included in the range where the difference in u/N from the ZC sequence of sequence group 2 in a 3-RB transmission bandwidth is within 0.02 (the dotted frame shown in FIG. 7), is smaller than as in a case of FIG. 2. By this means, the difference in u/N between ZC sequences of different sequence groups assigned to different cells is little likely to be close to zero, and therefore interference of sequences between cells is little likely to occur.

In this way, according to the present embodiment, intervals of sequence indexes of ZC sequences to use for reference signals are determined in accordance with sequence lengths. By this means, in each transmission bandwidth (i.e. in each number of RBs), it is possible to disperse u/Ns of ZC sequences to use for reference signals uniformly from 0 to 1. By this means, the difference in u/N between ZC sequences of varying sequence lengths in different sequence groups is little likely to be close to zero. Therefore, according to the present embodiment, it is possible to reduce the interference of sequences between cells to which different sequence groups are assigned. In addition, with the present embodiment, when ZC sequences to use for reference signals are determined, multiplying processing of sequence index interval Δ is only performed, so that it is possible to reduce the interference of sequences between cells without increasing the amount of processing.

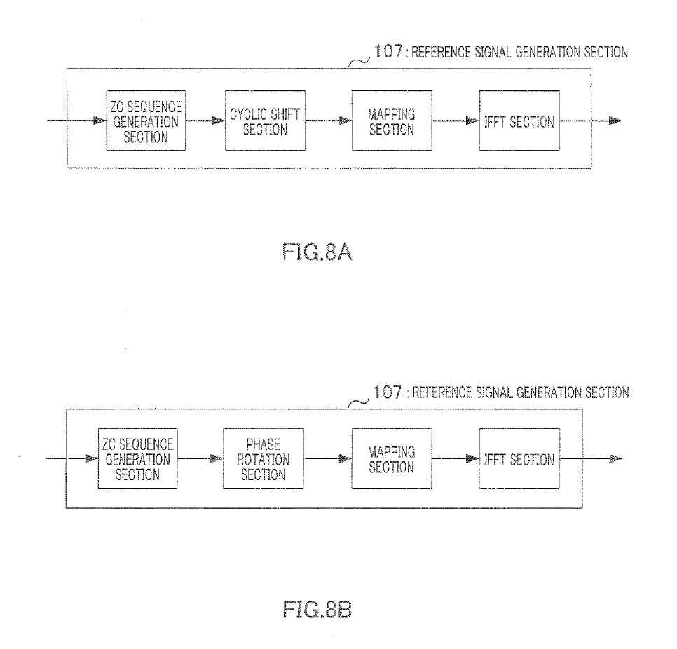

Further, although a case has been explained with the present embodiment where reference signal generation section 107 in terminal 100 is shown in FIG. 4, the section may be configured as shown in FIGS. 8A and 8B. Reference signal generation section 107 shown in FIG. 8A has a cyclic shift section before the IFFT section. Reference signal generation section 107 shown in FIG. 8B has a phase rotation section instead of the cyclic shift section before the IFFT section. This phase rotation section performs phase rotation as equivalent frequency-domain processing instead of cyclic-shifting in the time domain. That is, the amounts of phase rotation corresponding to the amounts of cyclic shift are assigned to subcarriers. These configurations make it possible to reduce the interference between sequences.

Further, although a case has been explained with the present embodiment where a frequency-domain ZC sequence (equation 3) is generated, it is equally possible to generate a time-domain ZC sequence (equation 1).

### Embodiment 2

With the present embodiment, sequence indexes having the same smallest u/N value are determined at the start positions of ZC sequences to use for reference signals in a plurality of ZC sequences of varying sequence lengths.

Now, an example of determining sequence indexes in sequence index determination section 105 of terminal 100 (FIG. 4) and sequence index determination section 164 of base station 150 (FIG. 5) will be explained.

Here, the same transmission bandwidths (i.e. the same numbers of RBs), sequence lengths N and sequence groups are used as transmission bandwidths (i.e. the numbers of RBs), sequence lengths N and sequence groups shown in FIG. 6 of Embodiment 1. Further, intervals Δ between sequence indexes of ZC sequences to use for reference signals in each transmission bandwidth are the same values as in Embodiment 1 shown in FIG. 6.

Specifically, the start position of ZC sequences to use for reference signals in each transmission bandwidth is determined to be the value obtained by dividing the number of ZC sequences that can be generated in each sequence length by the number of a plurality of sequence groups acquired by grouping into a plurality of different ZC sequences of varying sequence lengths. That is, the start position u_{INI} of a ZC sequence to use for a reference signal in each transmission bandwidth is calculated by following equation 9,

u_{INI}=floor((number of ZC sequences that can be generated in transmission bandwidth(sequence length N): N−1)/(number of sequence groups)) (Equation 9)

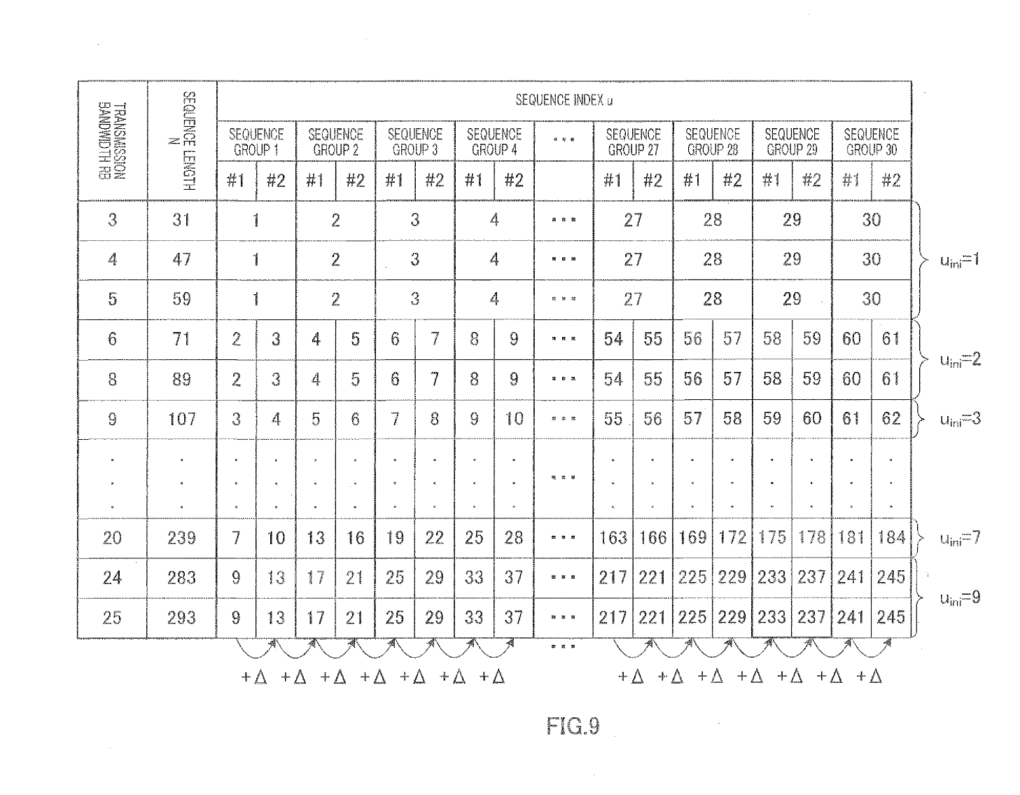

For example, as shown in FIG. 9, in the 3-RB transmission bandwidth, the number of ZC sequences that can be generated is 30 (=31−1), and therefore u_{INI}=floor(30/30)=1. Likewise, in the 4-RB transmission bandwidth, the number of ZC sequences that can be generated is 46 (˜47−1), and therefore u_{INI}=floor(46/30)=1.

Further, as shown in FIG. 9, in the 24-RB transmission bandwidth, the number of ZC sequences that can be generated is 282 (=283−1), and therefore u_{INI}=floor(282/30)=9. Further, in the 25-RB transmission bandwidth, the number of ZC sequences that can be generated is 292 (=293−1), and therefore u_{INI}=floor(292/30)=9. The same will apply to transmission bandwidths of 5 RBs to 20 RBs.

Then, a sequence index is assigned to sequence groups in ascending order from sequence index u=u_{INI} at Δ intervals in each transmission bandwidth. To be more specific, in transmission bandwidths of 3 RBs to 5 RBs to which one sequence is assigned per one sequence group, sequence indexes are assigned according to equation 10, and transmission bandwidths of 6-RBs or more to which two sequences are assigned per sequence group, sequence indexes #1 and #2 are assigned according to equations 11 and 12.

Sequence index=(G−1)ΔΔ+u_{INI} (Equation 10)

Sequence index #1=(G−1)×2×Δ+u_{INI} (Equation 11)

Sequence index #2=sequence index #1+Δ (Equation 12)

Here, G represents the sequence group index (here, G=1 to 30).

Accordingly, as shown in FIG. 9, in the 3-RB transmission bandwidth (start position u_{INI}=1 and interval Δ=1), sequence index u=1 (=(1−1)×1+1) is assigned to sequence group 1, sequence index u=2 (=(2−1)×1+1) is assigned to sequence group 2, and sequence index u=3 (=(3=1)×1+1) is assigned to sequence group 3 by equation 10. The same will apply to sequence groups 4 to 30.

Further, as shown in FIG. 9, in the 25-RB transmission bandwidth (start position u_{INI}=9 and interval Δ=4), sequence index u=9 (=(1−1)×2×4+9) is assigned as sequence index #1 to sequence group 1, and sequence index u=13 (−9+4) is assigned as sequence index #2 to sequence group 1 by equations 11 and 12. Likewise, sequence index u=17 (=(2−1)×2×4+9) is assigned as sequence index #1 to sequence group 2, sequence index u=21 (=17+4) is assigned as sequence index #2 to sequence group 2. Further, sequence index u=25 (=(3−1)×2×4+9) is assigned as sequence index #1 to sequence group 3, sequence index u=29 (=25+4) is assigned as sequence index #2 to sequence group 3. The same will apply to sequence groups 4 to 30.

Regarding transmission bandwidths of 4 RBs to 24 RBs, sequence indexes are assigned in the same way.

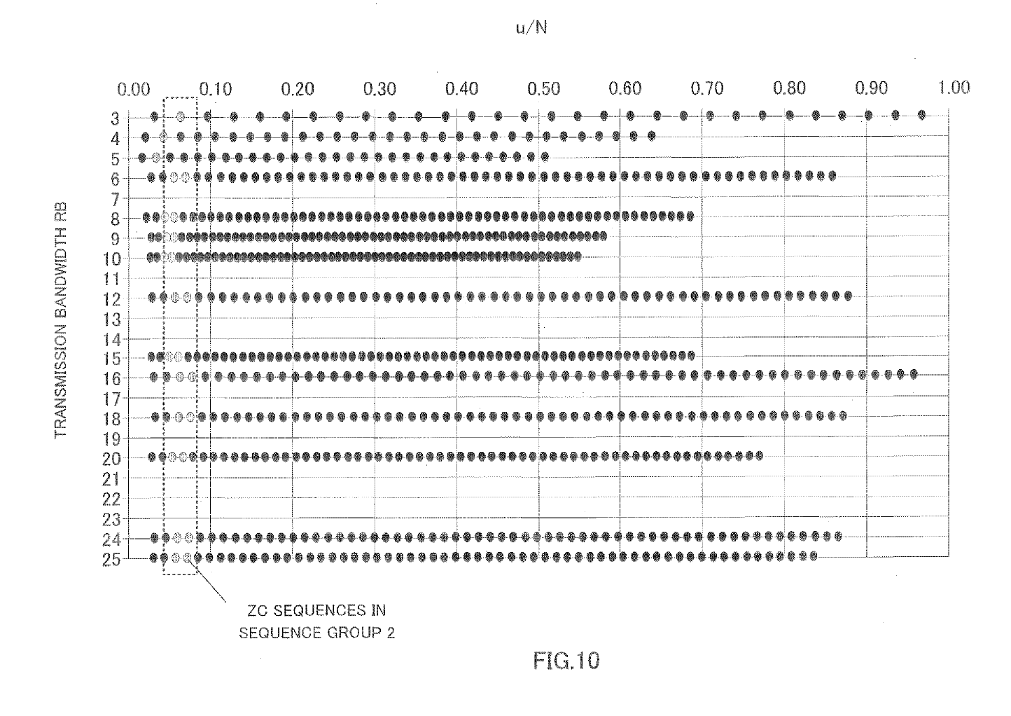

Next, FIG. 10 shows the distribution of u/Ns of the ZC sequences to use for reference signals (i.e. ZC sequences assigned in the table shown in FIG. 9). That is, as shown in FIG. 10, similar to the distribution of u/Ns shown in FIG. 7 of Embodiment 1, u/Ns of ZC sequences to use for reference signals are distributed evenly in a range from 0 to 1 at Δ/N intervals in each transmission bandwidth (i.e. in each number of RBs). Accordingly, as in Embodiment 1, u/Ns between ZC sequences of different transmission bandwidths (varying sequence lengths) are little likely to be the same, that is, the difference in u/N between ZC sequences is little likely to be close to zero.

With the distribution of u/Ns shown in FIG. 7 of Embodiment 1, in all transmission bandwidths (i.e. in all numbers of RBs), the head ZC sequences to use for reference signals are the ZC sequence of sequence index u=1. That is, the smallest value among the distribution of u/Ns shown in FIG. 7 is 1/N. That is, the smallest value among the distribution of u/Ns becomes close to zero when sequence length N is greater. By contrast with this, as shown in FIG. 10, the smallest u/N value of ZC sequences to use for reference signals is approximately the same in any transmission bandwidth (i.e. in any number of RBs). To be more specific, in the distribution of u/Ns shown in FIG. 10, the smallest u/N value of ZC sequences to use for reference signals is near 0.03 in each transmission bandwidth (i.e. in each number of RBs).

By this means, u/Ns of a plurality of ZC sequences of varying sequence lengths included in a sequence group are approximately the same when the sequence group has a smaller sequence group index. Specifically, as shown in FIG. 10, in the range where the difference in u/N from the ZC sequence in sequence group 2 in the 3-RB transmission bandwidth is within 0.02 (the dotted frame shown in FIG. 10), many ZC sequences in sequence group 2 in other transmission bandwidths (i.e. other numbers of RBs) are included. In other words, u/Ns of ZC sequences of different sequence groups are little likely to be included in the same range. Specifically, the number of ZC sequences in sequence groups other sequence groups included in a range where the difference in u/N from the ZC sequence in sequence group 2 in a 3-RB transmission bandwidth is within 0.02 (the dotted frame shown in FIG. 10), is much smaller than as in a case of FIG. 7.

By this means, the difference in u/N between ZC sequences of different sequence groups assigned to different cells is much little likely to be close to zero, and therefore interference of sequences between cells is little likely to occur. ZC sequences in different transmission bandwidths (i.e. different numbers of RBs) in the same sequence group use different frequencies by scheduling in a base station, and therefore interference between sequences does not occur.

In this way, according to the present embodiment, the start positions where the smallest u/N values are the same are determined in a plurality of ZC sequences of varying sequence lengths. By this means, when u/Ns of ZC sequences near the head of each transmission bandwidth (i.e. each number of RBs) have approximately the same value, that is, when sequence groups have smaller sequence group indexes, the difference in u/N between ZC sequences forming sequence groups is closer to zero. That is, the difference in u/N between ZC sequences in different sequence groups is little likely to be close to zero. That is, according to the present embodiment, it is possible to reduce the interference of sequences between cells as compared with the case of Embodiment 1.

With the present embodiment, start positions u_{INI} may be determined such that u/Ns are divided into predetermined intervals in a range from 0 to 1, to make the number of ZC sequences included in each range of u/Ns uniform. By this means, the u/Ns of ZC sequences to use for reference signals can be dispersed uniformly between 0 and 1, so that it is possible to further reduce interference of sequences between cells.

### Embodiment 3

With Embodiment 2, as shown in FIG. 10, u/Ns of a plurality of ZC sequences of varying sequence lengths included in the same sequence group are the same, in sequence groups having smaller sequence group indexes. However, u/Ns of ZC sequences of varying sequence lengths in different transmission bandwidths (i.e. different numbers of RBs) included in the same sequence group have different values when the sequence group has a greater sequence group index. That is, the ZC sequences having sequence group indexes included in greater sequence groups are more likely to have difference in u/Ns from ZC sequences of varying sequence lengths included in other sequence groups close to zero.

Then, with the present embodiment, a plurality of ZC sequences that can be generated in each sequence length are grouped into a plurality of ranges, and, sequence indexes of the same u/N in a plurality of ZC sequences having varying sequence lengths in each of a plurality of ranges are determined as the start positions of ZC sequences to use for reference signals.

Now, setting example 1 and setting example 2 of determining sequence indexes in sequence index determination section 105 of terminal 100 (FIG. 4) and sequence index determination section 164 of base station 150 (FIG. 5) will be explained.

In the following explanation, the same transmission bandwidths (i.e. the same numbers of RBs), sequence lengths N and sequence groups are used as transmission bandwidths (i.e. the numbers of RBs), sequence lengths N and sequence groups shown in FIG. 6 of Embodiment 1. Further, intervals Δ between sequence indexes of ZC sequences to use for reference signals in each transmission bandwidth are the same values as in Embodiment 1 shown in FIG. 6. The number of divisions of ZC sequences in each transmission bandwidth (i.e. in each number of RBs) is two. That is, ZC sequences of each transmission bandwidth (i.e. of each number of RBs) (sequence length N) are grouped into range 1 of sequence indexes u=1 to (N−1)/2 and range 2 of sequence indexes u=(N−1)/2+1 to N−1. Further, ZC sequences in range 1 are assigned to sequence groups 1 to 15 and ZC sequences in range 2 are assigned to sequence groups 16 to 30.

(Setting Example 1)

With the present setting example, sequence indexes are determined in ascending order from the smallest sequence index at Δ intervals in each plurality of ranges.

Now, a detailed explanation will be provided below. The number of grouping ZC sequences is two, and therefore, the start position u_{INI2} of sequence indexes of ZC sequences to use for reference signals in each transmission bandwidth in range 2 is calculated by following equation 13,

u_{INI2}=ceil((sequence length N)/2) (Equation 13)

where, ceil(x) means rounding up after the decimal point of x.

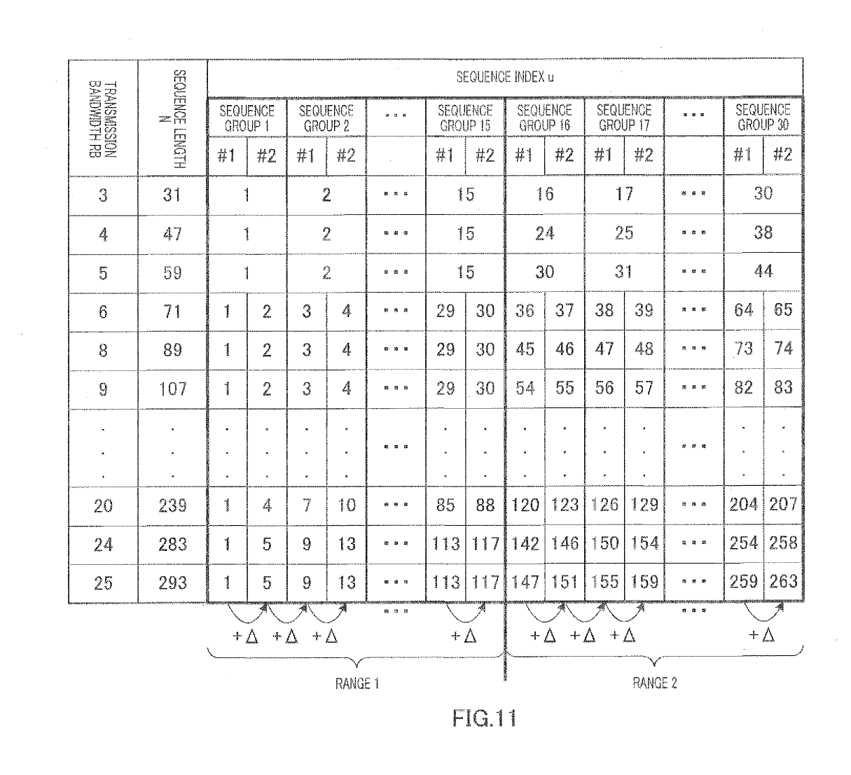

For example, as shown in FIG. 11, in the 3-RB transmission bandwidth, sequence length N−31, and therefore u_{INI2}=ceil(31/2)=16. Likewise, in the 4-RB transmission bandwidth, sequence length N=47, and therefore u_{INI2}=ceil(47/2)=24. Further, as shown in FIG. 11, in the 24-RB transmission bandwidth, sequence length N=283, and therefore u_{INI2}=ceil(283/2)=142. Likewise, in the 25-KB transmission bandwidth, sequence length N=293, and therefore u_{INI2}=ceil(293/2)=147. The same will apply to transmission bandwidths of 5 RBs to 20 RBs. That is, the smallest sequence index is determined to be start position u_{INI2}, among sequence indexes of ZC sequences in range 2.

Then, in each transmission bandwidth, sequence indexes are assigned to sequence groups in range 1 (i.e. sequence group indexes G=1 to M/2) using equations 6 to 8 of Embodiment 1 or equations 10 to 12 of Embodiment 2, where “M” represents the number of sequence groups. Meanwhile, in transmission bandwidths of 3 RBs to 5 RBs to which one sequence is assigned per one sequence group, sequence indexes are assigned to sequence groups in range 2 (i.e. sequence group indexes G=M/2+1 to M) according to equation 14, and, in transmission bandwidths of 6 RBs or more to which two sequences are assigned per sequence group, sequence indexes #1 and #2 are assigned to sequence groups in range 2 according to equations 15 and 16.

Sequence index=(G−M/2−1)×Δ+u_{INI2} (Equation 14)

Sequence index #1=(G−M/2−1)×2×Δ+u_{INI2} (Equation 15)

Sequence index #2=sequence index #1+Δ (Equation 16)

Accordingly, as shown in FIG. 11, in the 3-RB transmission bandwidth (interval Δ=1) of range 1 (sequence groups 1 to 15), similar to Embodiment 1, sequence index u=1 is assigned to sequence group 1, sequence index u=2 is assigned to sequence group 2, and sequence index u=3 is assigned to sequence group 3 by, for example, equation 6 of Embodiment 1. The same will apply to sequence groups 4 to 15. The same will apply to transmission bandwidths of 4 RBs to 25 RBs.

Meanwhile, as shown in FIG. 11, in the 3-RB transmission bandwidth of range 2 (sequence groups 16 to 30) (start position u_{INI2}=16 and interval Δ=1), sequence index u=16 (=(16−30/2−1)×1+16) is assigned to sequence group 16. Likewise, sequence index u=17 (=(17−30/2−1)×1+16) is assigned to sequence group 17, and sequence index u=30 (=(30−30/2−1)×1+16) is assigned to sequence group 30. Likewise, in the 25-RB transmission bandwidth (start position u_{UNI2}=147 and interval Δ=4) of range 2 (sequence groups 16 to 30), as shown in FIG. 11, sequence index u=147 (=(16−30/2−1)×2×4+147) is assigned as sequence index #1 to sequence group 16, and sequence index u=151 (=147+4) is assigned as sequence index #2 to sequence group 16. Further, sequence index u=155 (=(17−30/2−1)×2×4+147) is assigned as sequence index #1 to sequence group 17, and sequence index u=159 (=155+4) is assigned as sequence index #2 to sequence group 17. Likewise, sequence index u=259 (=(30−30/2−1)×2×4+147) is assigned as sequence index #1 to sequence group 30, and sequence index u=263 (=259+4) is assigned as sequence index #2 to sequence group 30. The same will apply to sequence groups 18 to 29.

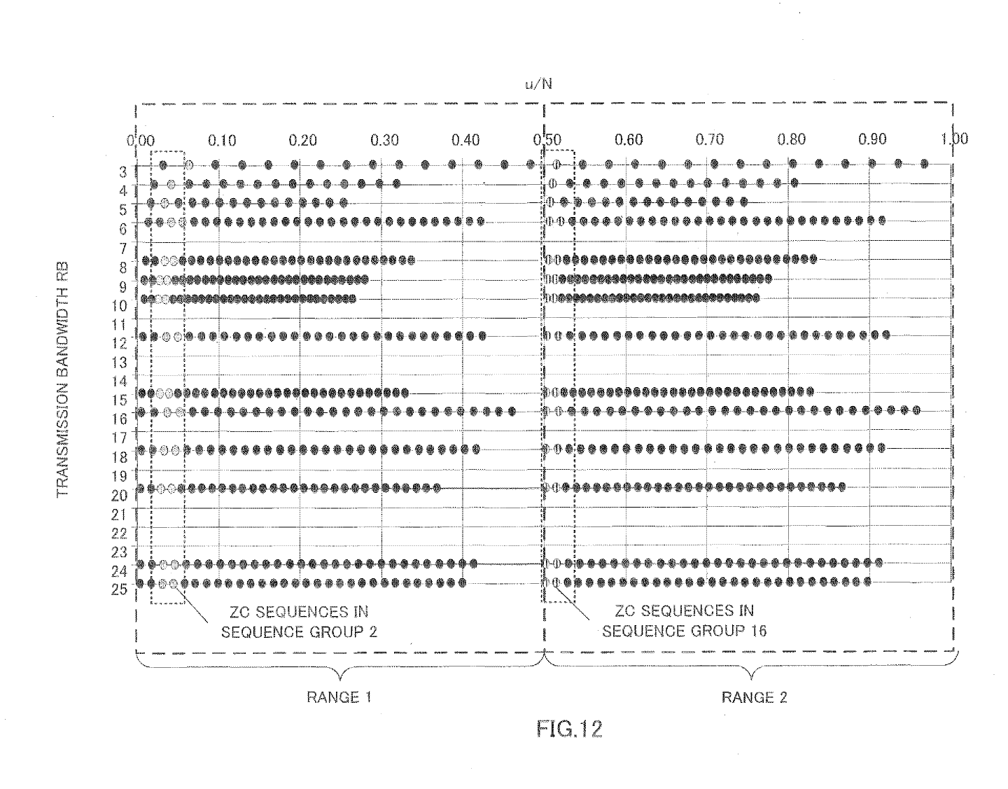

Next, FIG. 12 shows the distribution of u/Ns of the ZC sequences to use for reference signals (i.e. ZC sequences assigned in the table shown in FIG. 11). In range 1 shown in FIG. 12, the smallest u/N value of ZC sequences to use for reference signals is approximately the same in any transmission bandwidth (i.e. any number of RBs). To be more specific, in the distribution of u/Ns shown in FIG. 10, the smallest u/N value of ZC sequences to use for reference signals is near 0.00 in each transmission bandwidth (i.e. in each number of RBs).

Meanwhile, in range 2 shown in FIG. 12, the smallest u/N value of ZC sequences to use for reference signals is approximately the same in any transmission bandwidth (i.e. any number of RBs). To be more specific, in the distribution of u/Ns in range 2 shown in FIG. 12, the smallest u/N value of ZC sequences to use for reference signals is near 0.50 in each transmission bandwidth (i.e. in each number of RBs). In this way, in ranges 1 and 2, sequence indexes having the same smallest u/N value in each range are determined at the start positions of ZC sequences to use for reference signals.

By this means, it is possible to generate sequence groups in which u/Ns between ZC sequences of varying sequence lengths are approximately the same value in each of ranges 1 and 2. For example, as shown in FIG. 12, in range 1, many ZC sequences in each transmission bandwidth in sequence group 2 are included in a range where the u/Ns are near 0.02 and the difference in u/N is within 0.02. Likewise, in range 2, many ZC sequences in each transmission bandwidth in sequence group 16 are included in a range where the u/Ns are near 0.50 and the difference in u/N is within 0.02.

In this way, according to the present setting example, a plurality of ZC sequences that can be generated in each sequence length are grouped into a plurality of ranges, and, sequence indexes are determined in ascending order from the smallest sequence index at Δ intervals in each of a plurality of ranges. By this means, the number of sequence groups showing a difference in u/N between ZC sequences of varying sequence lengths close to zero increases. Consequently, the difference in u/N between ZC sequences in different sequence groups is much little likely to be close to zero, so that it is possible to reduce interference of sequences between cells as compared with the case of Embodiment 2.

(Setting Example 2)

With the present setting example, among a plurality of ranges, sequence indexes are determined in ascending order from the smallest sequence index at Δ intervals in one of ranges, and sequence indexes are determined in descending order from the greatest sequence index at Δ intervals in other ranges.

Now, a detailed explanation will be provided below. In each transmission bandwidth, similar to setting example 1, sequence indexes are assigned to sequence groups of range 1 (i.e. sequence group indexes G=1 to M/2) using equations 6 to 8 of Embodiment 1 or equations 10 to 12 of Embodiment 2, where, “M” represents the number of sequence groups. Meanwhile, in transmission bandwidths of 3 RBs to 5 RBs to which one sequence is assigned per one sequence group, sequence indexes are assigned to sequence groups of range 2 (i.e. sequence group indexes G=M/2+1 to M) according to equation 17, and, in transmission bandwidths of 6 RBs or more to which two sequences are assigned per sequence group, sequence indexes #1 and #2 are assigned to sequence groups of range 2 according to equations 18 and 19.

Sequence index=(G−M)×Δ+(N−1) (Equation 17)

Sequence index #1=sequence index #2−Δ (Equation 18)

Sequence index #2=(G−M)×2×Δ+(N−1) (Equation 19)

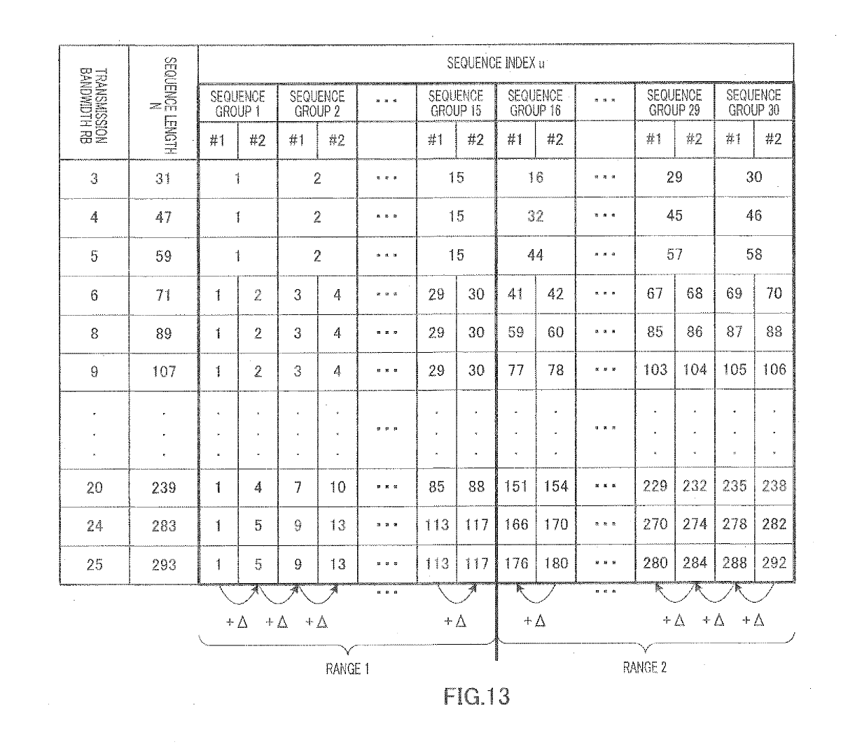

Accordingly, as shown in FIG. 13, in range 1 (sequence groups 1 to 15), for example, similar to setting example 1, sequence indexes are assigned in ascending order from smallest sequence index u=1 in each transmission bandwidth (i.e. in each number of RBs) at Δ intervals by equation 6 of Embodiment 1.

Meanwhile, as shown in FIG. 13, in range 2 (sequence groups 16 to 30), sequence indexes are assigned in descending order from greatest sequence index u=N−1 in each transmission bandwidth (i.e. in each number of RBs) at Δ intervals by equations 17 to 19. Specifically, in the 3-RB transmission bandwidth of range 2 (sequence groups 16 to 30) (interval Δ=1), sequence index u=30 (=(30−30)×1+(31−1)) is assigned to sequence group 30 by equation 17. Likewise, sequence index u=29 (=(29−30)×1+(31−1)) is assigned to sequence group 29, and sequence index u=16 (=(16−30)×1+(31−1)) is assigned to sequence group 16. The same will apply to sequence groups 28 to 17.

Further, in the 25-RB transmission bandwidth (interval Δ=4) of range 2 (sequence groups 16 to 30), as shown in FIG. 13, sequence index u=292 (=(30−30)×2×4+(293−1)) is assigned as sequence index #2 to sequence group 30, and sequence index u=288 (292−4) is assigned as sequence index #1 to sequence group 30. Further, sequence index u=284 (=(29−30)×2×4+(293−1)) is assigned as sequence index #2 to sequence group 29, and sequence index u=280 (=284−4) is assigned as sequence index #1 to sequence group 29. Likewise, sequence index u=180 (=(16−30)×2×4+(293−1)) is assigned as sequence index #2 to sequence group 16, and sequence index u=176 (=180−4) is assigned as sequence index #1 to sequence group 16. The same will apply to sequence groups 28 to 17.

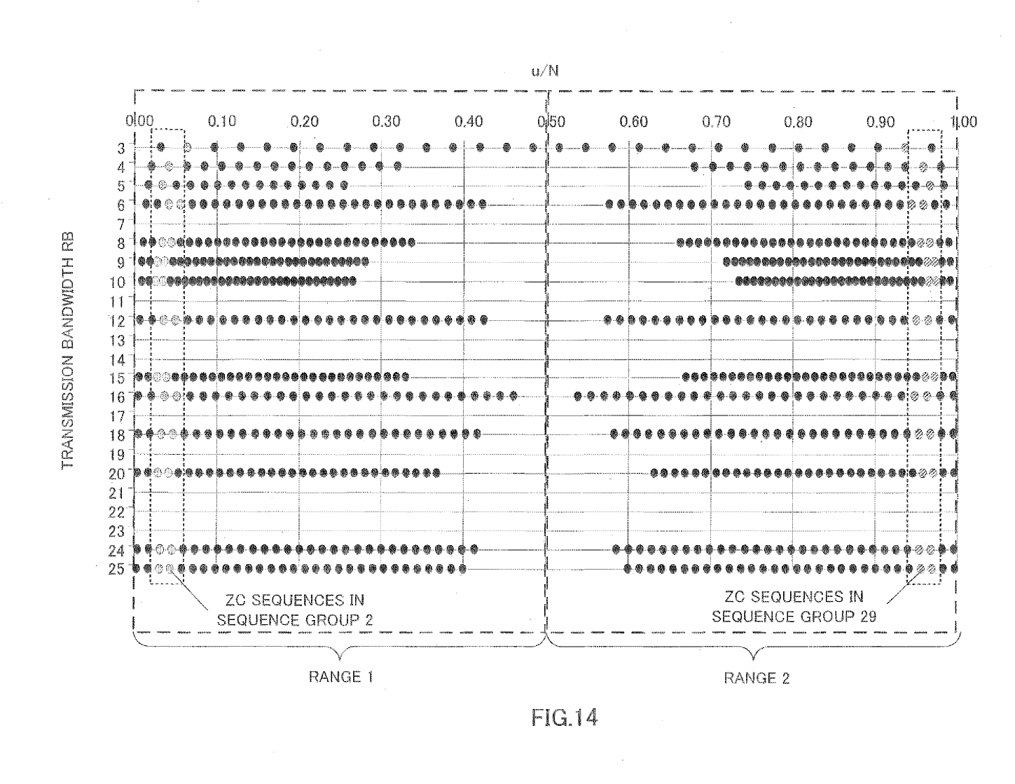

Next, FIG. 14 shows the distribution of u/Ns of the ZC sequences to use for reference signals (i.e. ZC sequences assigned in the table shown in FIG. 13). Similar to the distribution of u/Ns in FIG. 12 of setting example 1, in range 1 shown in FIG. 14, the smallest u/N value of ZC sequences to use for reference signals is approximately the same (near 0.00) in any transmission bandwidth (i.e. any number of RBs). Meanwhile, in range 2 shown in FIG. 14, the smallest u/N value of ZC sequences to use for reference signals is approximately the same (near 1.00) in any transmission bandwidth (i.e. any number of RBs). That is, the sequence index having the smallest u/N value (near 0.0) is determined at the start position of ZC sequences to use for reference signals in range 1, and the sequence index having the greatest u/N value is determined at the start positions of ZC sequences to use for reference signals in range 2.

By this means, similar to setting example 1, it is possible to generate more sequence groups in which u/Ns between ZC sequences of varying sequence lengths are approximately the same value in ranges 1 and 2. Specifically, the difference in u/N becomes close to zero between ZC sequences included in the same sequence group within each range (e.g. sequence group 2 in range 1 and sequence group 29 in range 2 shown in FIG. 14). That is, the difference in u/N between ZC sequences in different sequence groups is little likely to be close to zero.

Further, while it is necessary to calculate the start position u_{INI2} of sequence indexes in range 2 with setting example 1, interval Δ of sequence indexes alone may be calculated with the present setting example. Accordingly, it is possible to determine sequence indexes of ZC sequences to use for reference signals using a smaller amount of processing.

In this way, according to the present setting example, it is possible to further reduce the amount of processing for determining the sequence indexes of ZC sequences to use for reference signals while obtaining the same advantage as in setting example 1.

A ZC sequence having the u/N of 0 and a ZC sequence having the u/N of 1 are the same sequences. That is, u/N=0 and u/N=1 can be viewed as continuous. Accordingly, ranges 1 and 2 shown in FIG. 14 are equivalent to the distribution where range 1 extends in the ascending direction of u/Ns and range 2 extends in the descending direction of u/Ns as a median value of u/N−0 or 1. Accordingly, with the present setting example, the start position u_{INI} where the median value of u/Ns in each transmission bandwidth is 0.5 may be determined as in Embodiment 2. That is, ZC sequences are assigned to sequence groups of range 1 in u/N descending order from the ZC sequence having u/N=0.5, and ZC sequences are assigned to sequence groups of range 2 in u/N ascending order from the ZC sequence having u/N=0.5. This provides the same advantage as the present setting example.

Setting examples 1 and 2 of the present embodiment have been explained.

In this way, according to the present embodiment, ZC sequences to use for reference signals are grouped into a plurality of ranges and sequence indexes are determined in each range. By this means, the number of sequence groups in which u/Ns of ZC sequences are the same value in each range increases, so that it is possible to further reduce the interference of sequences between cells as compared with the case of Embodiment 2.

Embodiments of the present invention have been explained.

Although cases have been explained with the above embodiments where a fixed value is used in each transmission bandwidth (i.e. in each number of RBs) as interval Δ between sequence indexes of ZC sequences to use for reference signals, with the present invention, interval Δ between sequence indexes of ZC sequences to use for reference signals may be set as variable between transmission bandwidths.

Further, although cases have been explained with the above embodiments where ZC sequences are assigned to sequence groups in order, that is, cases where intervals between sequence indexes of ZC sequences in the same sequence group are A, with the present invention, ZC sequences may be assigned, to sequence groups, in order, per one sequence, and the assignment may be repeated until predetermined numbers of sequences are assigned.

Further, with the above embodiments, interval Δ between sequence indexes of ZC sequences to use for reference signals in each transmission bandwidth is not limited to the above values, and, for example, an upper limit value may not be set. When a sequence index calculated using interval Δ between sequence indexes exceeds the number of sequences that can be used in the transmission bandwidth, a sequence index may be calculated by cycling the sequence index to sequence index 1. That is, a result of modulo calculation of a calculated sequence index by the number of sequences that can be used in the transmission bandwidth may be used as a sequence index.

Although cases have been explained with the above embodiments where floor(x) is used in equations 5 and 9 and ceil(x) is used in equation 13, with the present invention, either floor(x), ceil(x) or round(x) may be used in equations 5, 9 and 13. Here, round(x) means rounding off after the decimal point of x.

Further, Δ, u_{INI} and u_{INI2} calculated in equations 5, 9 and 13 in the above embodiments may be calculated with decimals without rounding to an integer as described above (e.g. floor(x) and ceil(x)). In this case, rounding integer processing, that is, either floor(x), ceil(x) or round(x) may be performed for the sequence index acquired by using Δ, u_{INI} and u_{INI2}.

Although cases have been explained with the above embodiments where terminal 100 and base station 150 have the same table in advance, and transmission bandwidths and sequence groups, and sequence indexes are associated, according to the present invention, terminal 100 and base station 150 do not need to have the same table in advance, and it is not necessary to use a table by making association equivalent to the association among transmission bandwidths and sequence groups, and sequence indexes.

Further, although cases have been explained with the above embodiments as an example where the terminals transmits data and reference signals to the base station, it is equally possible to apply cases where the base station performs transmission for terminals.

Although cases have been explained with the above embodiments where a ZC sequence is used as a channel estimation reference signal, with the present invention, a ZC sequence may be used as a DM-RS (Demodulation RS), which is a demodulation reference signal for a PUSCH (Physical Uplink Shared Channel), a DM-RS, which is a demodulation reference signal for a PUCCH (Physical Uplink Control Channel), and a sounding RS for received quality measurement. Further, a reference signal may be replaced with a pilot signal.

Further, the method of processing in base station 100 is not limited to the above and may be any method as long as the desired wave and interference waves can be separate. For example, cyclic-shifted ZC sequences instead of ZC sequences generated in ZC sequence generation section 166 may be outputted to division section 160. Specifically, division section 160 divides signals received as input from demapping section 159 by cyclic-shifted ZC sequences (the same sequences as the cyclic-shifted ZC sequences transmitted in the transmission side), and outputs the division results (correlation values) to IFFT section 161. Then, by masking the signals received as input from IFFT section 161, masking processing section 162 extracts the correlation value in the period where the correlation value of the desired cyclic shift sequence is present, and outputs the extracted correlation value to DFT section 163. Here, masking processing section 162 does not need to take into account the amount of cyclic shift upon extracting the period where the correlation value of the desired cyclic shift sequence is present. These processing make it possible to separate the desired wave and interference waves from a received wave.

Although cases have been explained with the above embodiments as an example of a ZC sequence having an odd-numbered sequence length, the present invention may be applicable to a ZC sequence having an even-numbered sequence length. Further, the present invention may be applicable to a GCL (Generalized Chirp Like) sequence including a ZC sequence. Now, a GCL sequence will be represented using equations. A GCL sequence of sequence length N is represented by equation 20 when N is an odd number, or represented by equation 21 when N is an even number.

$$\begin{matrix}( Equation 20 ) & \\ {c}_{r , m} ( k ) = exp \{ \frac{- j2π r}{N} ( \frac{k ( k + 1 )}{2} + qk ) \} {b}_{i} ( k mod m ) & [ 5 ] \\ ( Equation 21 ) & \\ {c}_{r , m} ( k ) = exp \{ \frac{- j2π r}{N} ( \frac{{k}^{2}}{2} + qk ) \} {b}_{1} ( k mod m ) & [ 6 ]\end{matrix}$$

Here, k=0, 1, . . . and N−1, “N” and “r” are coprime, and r is an integer smaller than N. Also, “p” represents an arbitrary integer (generally p=0). Also, bᵢ(k mod m) is an arbitrary complex number and i=0, 1, . . . and m−1. To minimize cross-correlation between GCL sequences, an arbitrary complex number of amplitude 1 is to use for bᵢ(k mod in). In this way, the GCL sequences represented by equations 20 and 21 are found by multiplying bᵢ(k mod m) by ZC sequences represented by equations 1 and 2.

Further, the present invention may be applicable to binary sequences and other CAZAC sequences where a cyclic shift sequence or ZCZ sequence is to use for a coding sequence. For example, there are Frank sequences, random CAZAC sequences, OLZC sequences, RAZAC sequences, other CAZAC sequences (including sequences generated by computers) and PN sequences including M sequences and gold sequences.

Furthermore, a modified ZC sequence obtained by puncturing, performing cyclic extension or performing truncation on a ZC sequence may be applied.

Further, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-337240, filed on Dec. 27, 2007, including the specification, drawings and abstract, is incorporated herein by reference in its entirety.

### INDUSTRIAL APPLICABILITY

The present invention is applicable to, for example, mobile communication systems.

1. A sequence index setting method that uses as a reference signal a Zadoff-Chu sequence having a sequence length in accordance with a transmission bandwidth of the reference signal, the method comprising determining an interval between sequence indexes of the Zadoff-Chu sequences in accordance with the sequence length.

2. The sequence index setting method according to claim 1, wherein the interval is determined to be a value obtained by dividing a number of Zadoff-Chu sequences that can be generated in the sequence length by the number of Zadoff-Chu sequences to use for the reference signal.

3. The sequence index setting method according to claim 1, wherein, a sequence index having a same smallest u/N value (u: sequence index and N: sequence length) in a plurality of Zadoff-Chu sequences of varying sequence lengths is determined at a start position of the Zadoff-Chu sequences to use for the reference signal.

4. The sequence index setting method according to claim 3, wherein the start position is determined to be a value obtained by dividing the number of Zadoff-Chu sequences that can be generated in the sequence length by the number of a plurality of sequence groups grouping Zadoff-Chu sequences of varying sequence lengths.

5. The sequence index setting method according to claim 1, wherein a plurality of Zadoff-Chu sequences that can be generated in the sequence length are grouped into a plurality of ranges, and, sequence indexes of the same u/N (u: sequence index and N: sequence length) in a plurality of Zadoff-Chu sequences of varying sequence lengths in each of the plurality of ranges are determined as start positions of the Zadoff-Chu sequences to use for the reference signal.

6. The sequence index setting method according to claim 1, wherein a plurality of Zadoff-Chu sequences that can be generated in the sequence length are grouped into a plurality of ranges, and, in each of the plurality of ranges, sequence indexes are determined at the intervals in ascending order from the smallest sequence index.

7. The sequence index setting method according to claim 1, wherein a plurality of Zadoff-Chu sequences that can be generated in the sequence length are grouped into a plurality of ranges, and, in each of the plurality of ranges, a sequence index of the smallest u/N value (u: sequence index and N: sequence length) is determined as a start position.

8. The sequence index setting method according to claim 1, wherein a plurality of Zadoff-Chu sequences that can be generated in the sequence length are grouped into a plurality of ranges, and, sequence indexes are determined at the intervals in ascending order from the smallest sequence index in one of the plurality of ranges, and, sequence indexes are determined at the intervals in descending order from the greatest sequence index in ranges other than the one of the plurality of ranges.

9. The sequence index setting method according to claim 1, wherein a plurality of Zadoff-Chu sequences that can be generated in the sequence length are grouped into a plurality of ranges, and, a sequence index having the smallest u/N value (u: sequence index and N: sequence length) in one of the plurality of ranges is determined as a start position, and, a sequence index having the greatest u/N value in ranges other than the one of the plurality of ranges is determined as the start position.

10. A radio communication terminal apparatus comprising:
a determination section that determines a sequence index of a Zadoff-Chu sequence based on association between reference signal transmission bandwidths and sequence indexes of Zadoff-chu sequences; and
a generation section that generates Zadoff-Chu sequences based on the determined sequence index,
wherein an interval between sequence indexes of the Zadoff-Chu sequences to use for the reference signal is determined in accordance with a sequence length.

11. A radio communication base station apparatus comprising:
a determination section that determines a sequence index of a Zadoff-Chu sequence based on association between reference signal transmission bandwidths and sequence indexes of Zadoff-chu sequences; and
a generation section that generates Zadoff-Chu sequences based on the determined sequence index,
wherein an interval between sequence indexes of the Zadoff-Chu sequences to use for the reference signal is determined in accordance with a sequence length.
